(19) United States
(12) Patent Application Publication
(10) Pub. No.: US 2025/0222721 A1
(43) Pub. Date: Jul. 10, 2025

(54) ONE-PIECE ALUMINUM LIVE AXLE CARRIER CONSTRUCTED FROM LOW PRESSURE DIE CASTING FOR MOTOR VEHICLES

(71) Applicant: Martinrea International US Inc., Auburn Hills, MI (US)

(72) Inventors: Ranvir Jalf, Troy, MI (US); Ian Long, Almont, MI (US); Daniel Ramos, Troy, MI (US); Tom Buchler, Grand Blanc, MI (US); Tyler Kroes, Lake Orion, MI (US); Jonathan Burns, Windsor (CA); Jason Easlick, Lake Orion, MI (US); Steve Geddes, Ann Arbor, MI (US)

(21) Appl. No.: 19/011,722

(22) Filed: Jan. 7, 2025

Related U.S. Application Data
(60) Provisional application No. 63/618,411, filed on Jan. 8, 2024.

(51) Int. Cl. B60B 35/16

(52) U.S. Cl. CPC B60B 35/16; B60B 2310/202; B60B 2360/104

(57) ABSTRACT

A vehicle axle carrier having a one piece aluminum body produced by a low pressure die casting process and which integrates each of a differential housing, axle tubes, and attachment points for each of wheels/hubs, suspension struts, control links, jounce bumpers and electrical harnessing or brake line connections. Localized areas of the body, including the axle tubes exhibit varying thicknesses in order to compensate for the mechanical properties of aluminum. The low pressure die casting process accounts for each of die pull direction, draft angles and minimal wall thicknesses, with the aluminum body produced combining the features of lighter weight and infinite recyclability.

### CROSS REFERENCE TO RELATED APPLICATIONS

The present application claims the priority of USSN 63/618,411 filed Jan. 8, 2025.

### FIELD OF THE INVENTION

The present invention relates generally to axle carrier assemblies. More specifically, the present invention teaches a one-piece aluminum cast front or rear axle carrier or axle housing assemblies which integrates any combination of features including each of hubs, struts, jounce bumpers, leaf springs and other attachments.

### BACKGROUND OF THE INVENTION

The prior art includes contemporary automotive passenger vehicles having various front and rear end architectures for supporting the front and rear wheels, suspension and braking components. One such architecture, often used on light trucks, is the so-called rear live axle which is a multi-piece assembly including a differential gear housing with tubes extending outward toward the rear wheels.

Additional components may be bolted on, welded on or otherwise attached for a specific technical function of the assembly. The tubes envelop the rotating drive axle providing protection as well as multiple attachment points for the wheels/hubs, suspension struts, jounce bumper, and connection points for electrical harnessing or brake lines. Generally, multi-piece assemblies allow for tailoring individual components' material, design, and manufacturing process to meet the technical requirements and piece cost targets.

As with the rear axle carrier, a front axle carrier structure encases the differential gearing and a separate tube which extends laterally. The tube is often a bolt-on design. The joint between the tube and main body enclosing the differential gearing presents challenges for the performance of the system during the lifetime of the vehicle. First, the joint can create a leak point allowing gear oil to escape. Second, the tube can be misaligned to the main body which has negative effects for assembly and driving operation including wear and tear, noise, and premature failure.

More recent technology advancements in materials, manufacturing processes, or design tools have enabled improvements in automotive design, even if some subsystem architectures have remained in a recognizable form during its evolution. Recent design pressures in the auto industry, namely the rapid transition to electric vehicles (EVs) in place of those powered by internal combustion engine (ICE), have put a premium on mass efficiency to extend EV range for a given battery capacity.

Large-format aluminum castings have emerged as one design means to reduce mass by substitution of aluminum in place of multi-piece assemblies, of which many of those pieces are steel or other dense, heavy materials. In addition to mass reduction, ancillary benefits are seen in achieving a reduced part count. Efficiencies are seen in most parts of the automotive development and manufacture including reduced bill of materials (BOM) complexity, this generally defined as an extensive list of raw materials, components, and instructions required to construct, manufacture, or repair a product, as well as fewer parts for purchasing and inventory management, reduced factory floor space, lower labor needs, and so on.

Through in the nascent stage, large-format castings have typically replaced structural subassemblies such as the front or rear wheelhouse, front motor rails, front torque box, or the complete rear end ladder assembly (left and right longitudinals plus crossmember(s)). The technology is being used in mass production applications and is being implemented or explored by a growing number of automotive OEMs.

The recent trend shows increasing use of EV powertrains and a corresponding decrease in ICE-propelled vehicles. Governmental incentives and industry momentum will see this trend continue over the foreseeable future. Still, the balance of internal combustion engine (ICE)-propelled light trucks presents an opportunity for mass and part-count efficiency.

### SUMMARY OF THE INVENTION

The present invention discloses a one-piece live axle aluminum casting typically for use on light-duty pickup trucks or other light delivery vehicles propelled by internal combustion (ICE) engines. More specifically, the present invention teaches either of a front or rear live axle carrier assembly for securing and protecting the axle and differential gear mechanisms which is characterized by a one-piece, aluminum die casting and including a plurality of integrated provisions for each of hubs, struts, jounce bumpers, leaf springs, and other attachments as may be needed for any particular design.

The invention discloses each of front and rear axle carriers. In the instance of a rear live axle carrier (this defined as a structure for the rear axle which extends across the vehicle between the rear wheels), such includes a one-piece, aluminum axle carrier having a differential housing, axle tubes, hub mounts, strut mounts, jounce bumper surfaces, spring seats, and other features, as necessary, made via the low pressure die casting (LPDC) method. Localized areas as well as the tubular zones which extend laterally from the differential housing are further constructed such that they are thickened to compensate for the mechanical properties of aluminum, which has reduced strength as compared to typical materials used in conventional axle carriers. The front axle carrier is shorter in cross-vehicle width as compared to the rear “live” axle in order to accommodate independent wheel suspension and steering motion, but is similar in that it provides an encasement structure for the differential gearing and outputs which transmit drive energy to the wheels.

The present invention also discloses a corresponding low pressure die casting (LPDC) method and process for producing the one piece aluminum rear live and front axle carrier. Modeling has taken into account characteristics which aid in manufacturing such as die pull direction, draft angles, minimum wall thickness, etc. Computer-aided engineering (CAE) modeling shows that strength, rigidity and durability are similar to the performance of the baseline design using a set of assumed loads for various driving, braking and road conditions (e.g, pothole).

An additional benefit is aluminum's natural resistance to corrosive forces, seen in a wide range of operating environments and seasons. Finally, aluminum is a so-called “infinitely recyclable” material which does not lose mechanical properties when recovered and reused. An estimated 5% of energy is used to recover/recycle aluminum as compared to the energy to obtain aluminum via mining. This, combined with the lower mass, reduces the carbon footprint of manufacturing and service life (via improved energy efficiency) as compared to baseline Axle Carriers.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 presents a perspective illustration of a current production multi-piece, multi-material rear axle carrier according to the Prior Art;

FIG. 2 is a corresponding illustration similar to FIG. 1 of a one piece low pressure die casted aluminum live axle carrier according to the present invention;

FIGS. 3-5 present a series of perspective, rear plan and ninety degree rotated side plan views of the low pressure die casted one piece aluminum live axle carrier;

FIG. 6 is a perspective view of a one piece low pressure die casted aluminum front axle carrier according to a further embodiment of the present invention;

FIG. 7 is a succeeding view to FIG. 6 with the cover removed from the front axle carrier;

FIG. 8 presents a perspective illustration of a one piece low pressure die casted aluminum live axle carrier according to a further embodiment of the present invention; and

FIGS. 9-11 present a series of perspective, rear plan and ninety degree rotated side plan views of the low pressure die casted one piece aluminum live axle carrier.

### DETAILED DESCRIPTION OF THE PREFERRED EMBODIMENTS

With reference to the attached illustrations, the present invention discloses a one-piece aluminum cast rear live or front axle carrier, such integrating each of hubs, struts, jounce bumpers, leaf springs and other attachments. More specifically, the present invention teaches an apparatus and associated process of an automobile for securing and protecting the axles and differential gear mechanism characterized by a one-piece, aluminum die casting and including a plurality of integrated provisions for hubs, struts, jounce bumpers, leaf springs, and other attachments as may be needed for any particular front or rear axle carrier design.

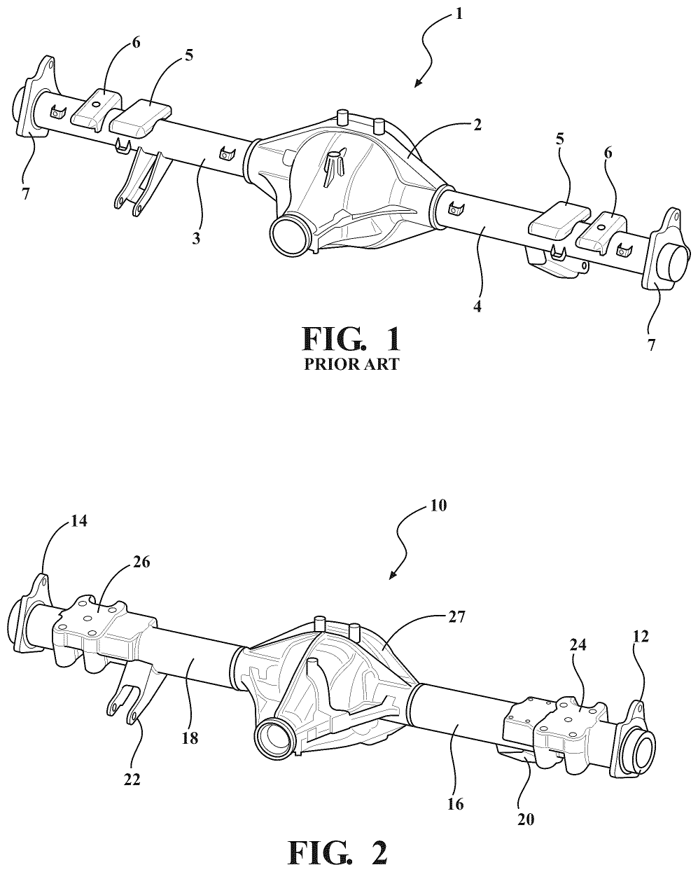

Referring initially to FIG. 1, an illustration is shown, generally at 1, of a current production multi-piece, multi-material rear axle carrier according to the Prior Art. An axle carrier (also termed a differential carrier assembly) is provided as a group of components that includes each of a center differential housing casting (typically iron), left 3 and right 4 axle carrier tubes, along with separate attachment components including hubs, struts, jounce bumpers, leaf springs, spindle plates and other attachments (further representatively identified at 5, 6, 7, et seq.), along with left 8 and right 9 strut connections. The spindle plates, again identified at 7, define the ends of the carrier assembly and are connected to the ends of the axle carrier tubes 3 and 4. As is further known, the tubes 3 and 4 each exhibit a complex inner profile including non-uniform wall thickness requiring a special manufacturing process for completion.

With reference to FIG. 2, a corresponding illustration similar to FIG. 1 is generally depicted at 10 of a one-piece low pressure die casted aluminum live axle carrier according to the present invention. In comparison to the Prior Art axle carrier 1 of FIG. 1, the present invention integrates the axle carrier structure from the opposite end mounted spindle plates (depicted here at 12/14) which are respectively integrated into axle carrier tubes 16 and 18.

The one-piece die casted construction of the aluminum live axle carrier integrates all attachment features which are separately produced and post-fabrication attached in the prior art carrier of FIG. 1, and include such as left/right strut connections 20/22 and leaf springs 24/26. The one-piece, aluminum axle carrier incorporates each of the differential casing or housing, at 27, for housing the rear differential unit, with the axle tubes again at 16/18, hub mounts, strut mounts, jounce bumper surfaces, spring seats, and other features, as necessary, formed as part of the integrated housing via the low pressure die casting (LPDC) method described herein.

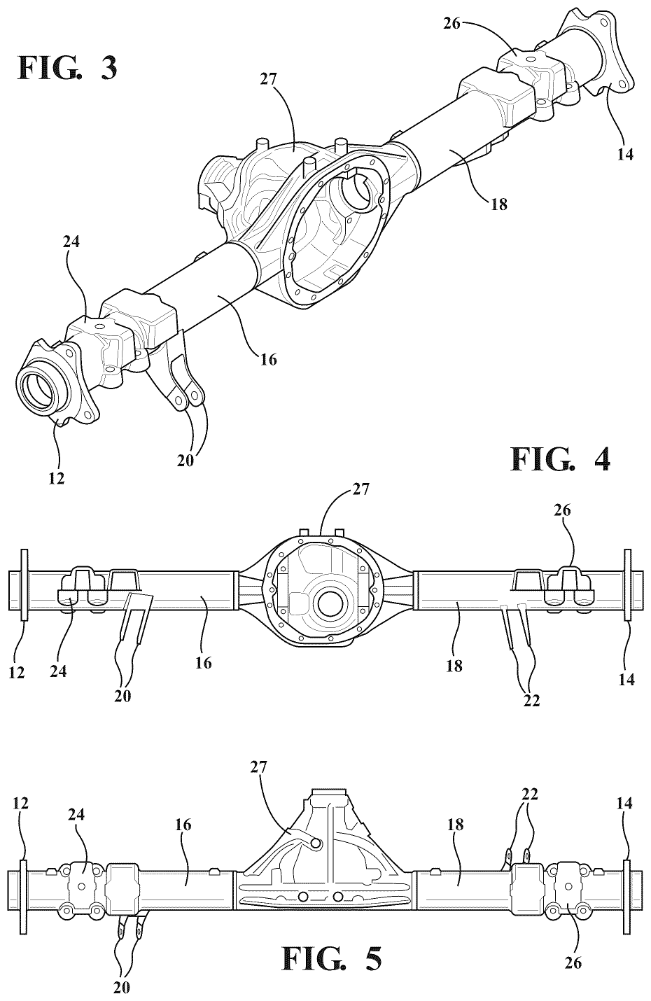

As is further known, localized areas as well as the tubular zones 16/18 which extend laterally from the differential housing 27 (see in particular the perspective view of FIG. 3 which reveals the open interior of the central case portion of the housing 27 prior to installation of the separate differential unit) are thickened to compensate for the mechanical properties of aluminum, which as is further known has reduced strength compared to the typical materials used in other conventional axle carriers.

Proceeding to FIGS. 3-5, presented are a series of perspective, rear plan and ninety degree rotated side plan views of the low pressure die casted one piece aluminum live axle carrier 10 of FIG. 2, with a serviceable removable center close out plate (not shown) removed. Although not shown, the rear live axle housing seats an input or pinion shaft which engages the components of the installed differential unit contained in the housing (pinion gear, differential drive ring gear, differential pinion gear and differential side gears), in turn communicating with an axle or drive shaft extending to the rear wheels. Following installation of the interior components of the live axle carrier a close out plate (not shown) is installed to complete the assembly.

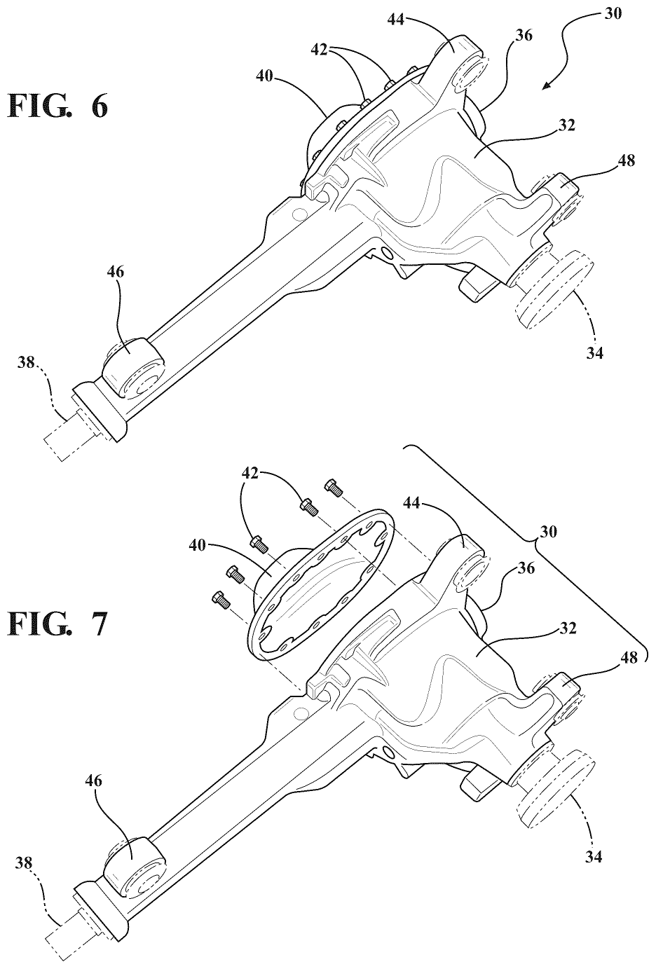

Proceeding to FIG. 6, a perspective view of a one piece low pressure die casted aluminum front axle carrier (also termed a transaxle) is shown generally at 30 according to a further embodiment of the present invention. The front axle carrier is shorter in cross-vehicle width to accommodate independent wheel suspension and steering motion, but is similar to the rear axle carrier in that it provides an encasement structure for the differential gearing and outputs which transmit drive energy to the wheels.

A main differential housing 32 is provided which seats the differential carrier and axle shaft (not shown). An input shaft (not shown however understood as extending from a rear of the vehicle) extends to the differential casing of the housing 32 and attaches at location 34 with the internal differential gearing incorporated within the casing 32. Rotational outputs of the installed differential unit are transmitted to left or right side interior supported axle shafts, at 36 and 38, extending to separate wheel locations.

A close out cover 40 is attached to the one-piece housing via attachment bolts 42, with FIG. 7 further depicting the cover 40 removed from the front axle carrier casing 32. Without limitation, similar covers are provided for each of the other front and rear axle carriers described and illustrated herein.

Also shown at each of 44, 46 and 48, are vehicle mount locations integrally formed with the one piece front axle carrier housing or casing. As with the rear axle carrier, the front axle carrier is provided as a single one-piece die casted construction of the aluminum live axle carrier which integrates all attachment features required for the front carrier (as compared to the attachments previously described incorporated into the rear live axle carrier 10 depicted in FIGS. 2-5).

In the instance of a front axle carrier, a common configuration uses a structure to encase the differential gearing and a short drive shaft extending laterally from one side of the gearing. The input drive shaft is typically offset laterally from the centerline of the vehicle, making the connecting points on the outboard sides of the differential off-center. A shorter extension shaft accounts for the offset and provides a connection point for the half shaft which is symmetrically positioned relative to the differential gearing output on the opposite side of the vehicle. The half shafts transmit rotation drive energy to the wheels and are engineered to allow independent up/down movement of the wheels and suspension system.

Additionally, the front axle carrier is shorter in cross-vehicle width as compared to the rear “live” axle in order to accommodate independent wheel suspension and steering motion, but is similar in that it provides an encasement structure for the differential gearing and outputs which transmit drive energy to the wheels. As with the rear “live” axle carrier 10, the front axle carrier 30 is produced according to a corresponding low pressure die casting (LPDC) method and process for producing the one piece aluminum axle carrier.

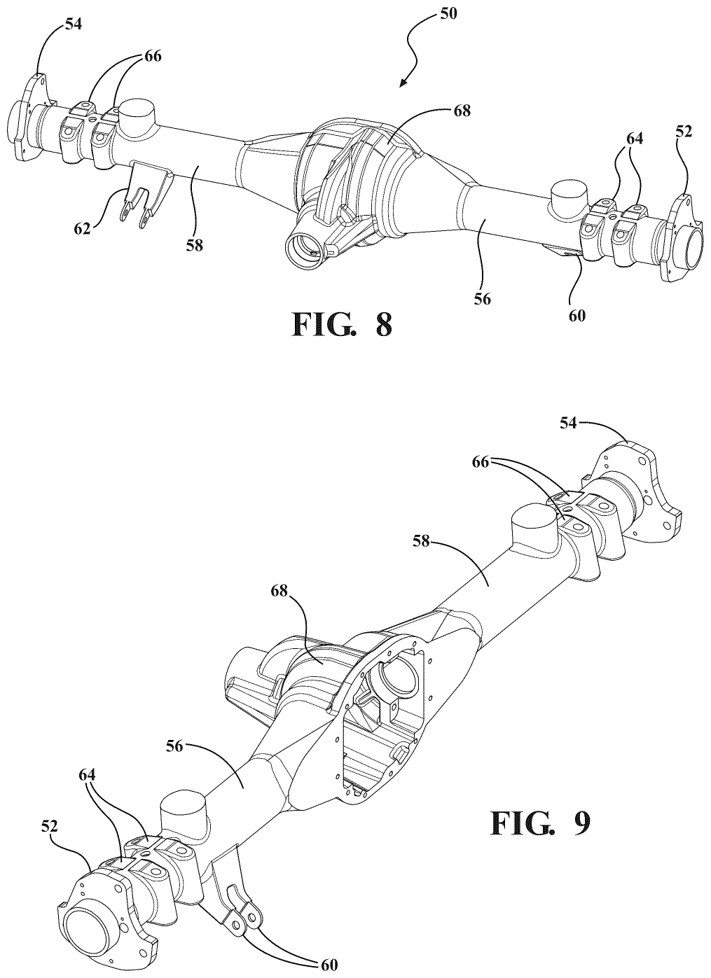

FIG. 8 presents a perspective illustration of a one piece low pressure die casted aluminum live axle carrier, generally at 50, according to a further embodiment of the present invention. As with the rear live axle carrier 10, the rear axle carrier 50 provides a similar construction with some reconfiguration and integrates opposite end mounted spindle plates 52/54 which are respectively integrated into axle carrier tubes 56 and 58.

The one-piece die casted construction of the aluminum live axle carrier 50 again integrates all attachment features which are separately produced and post-fabrication attached in the prior art carrier of FIG. 1, and which again include such as left/right strut connections 60/62 and leaf springs 64/66. The one-piece, aluminum axle carrier incorporates each of a central differential casing 68 for the rear differential unit, with the axle tubes 56/58 hub mounts, strut mounts, jounce bumper surfaces, spring seats, and other features, as necessary, formed as part of the integrated housing via the low pressure die casting (LPDC) method described herein.

As is further known, localized areas as well as the tubular zones 56/58, which extend laterally from the central differential housing 52, are thickened to compensate for the mechanical properties of aluminum, which as is further known has somewhat reduced strength compared to the typical materials used in other conventional axle carriers.

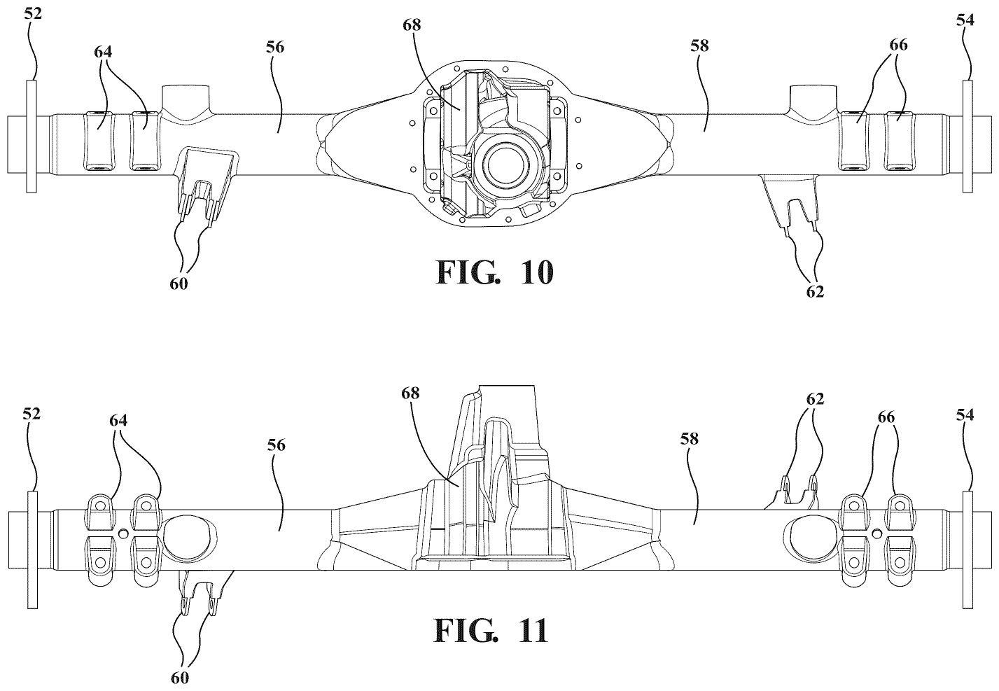

Finally, FIGS. 9-11 present a series of perspective, rear plan and ninety degree rotated side plan views of the low pressure die casted one piece aluminum live axle carrier with a serviceable removable center close out plate (again not shown) being removed to reveal the interior of the one piece casing or housing. As previously described, the rear live axle housing seats an input or pinion shaft which engages the components of the installed differential unit contained in the housing (again pinion gear, differential drive ring gear, differential pinion gear and differential side gears), in turn communicating with an axle or drive shaft extending to the rear wheels. Following installation of the interior components of the live axle carrier a close out plate (not shown) is installed to complete the assembly.

Other applications of the present assembly also include use with any of Salisbury axles, banjo axles, and other hybrid designs. Additionally, the present invention can be applied to any rear axle with a leaf spring-style suspension, this in addition to any multi-link+coil spring style suspension.

The present invention also discloses a corresponding low pressure die casting (LPDC) method and process for producing the one piece aluminum live axle carrier. While the use of LPDC is desirous in forming the one piece axle carrier, owing to the improved properties which are desirable, the present invention also contemplates utilizing alternative casting methods. Associated modeling for the casting aid in the manufacturing process and include such as the die pull direction, draft angles, minimum wall thickness, etc. associated with the completed assembly. Computer-aided engineering (CAE) modeling has further demonstrated that strength, rigidity and durability are similar to the performance of the baseline design using a set of assumed loads for various driving, braking and road conditions (e.g, pothole).

An additional benefit is aluminum's natural resistance to corrosive forces, seen in a wide range of operating environments and seasons. Finally, aluminum is a so-called “infinitely recyclable” material which does not lose mechanical properties when recovered and reused. An estimated 5% of energy is used to recover/recycle aluminum as compared to the energy to obtain aluminum via mining. This, combined with the lower mass, reduces the carbon footprint of manufacturing and service life (via improved energy efficiency) as compared to the baseline Axle Carrier.

Having described my invention, other and additional preferred embodiments will become apparent to those skilled in the art to which it pertains, and without deviating from the scope of the appended claims. The detailed description and drawings are further understood to be supportive of the disclosure, the scope of which being defined by the claims. While some of the best modes and other embodiments for carrying out the claimed teachings have been described in detail, various alternative designs and embodiments exist for practicing the disclosure defined in the appended claims.

The foregoing disclosure is further understood as not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosure. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application. Additionally, any signal hatches in the drawings/figures should be considered only as exemplary, and not limiting, unless otherwise specifically specified.

1. An axle carrier for a vehicle, comprising:
a one piece produced aluminum body including a central casing adapted to receive a differential unit containing a gear mechanism, along with first and second integrally formed axle tubes extending from said central casing and adapted to receive a drive axle shaft for connecting to wheels of the vehicle;
said one piece body incorporating attachment points for any of wheels/hubs, strut connections, leaf springs, control links, jounce bumpers, electrical harnessing or brake line connections; and
localized areas of said one piece body, including said axle tubes, exhibiting varying thicknesses to compensate for mechanical properties of aluminum.

2. The axle carrier of claim 1, further comprising said one piece body being produced according to a low pressure die casting (LPDC) method and process accounting for each of die pull direction, draft angles and minimal wall thicknesses.

3. The axle carrier of claim 1, said one piece body further comprising either of a front axle carrier or live rear axle carrier.

4. The axle carrier of claim 1, further comprising a separate close out cover attached to said one-piece body via attachment bolts.
